(19) United States
(12) Patent Application Publication
(10) Pub. No.: US 2014/0282077 A1
(43) Pub. Date: Sep. 18, 2014

(54) SOFTWARE-BASED TOOL FOR DIGITAL IDEA COLLECTION, ORGANIZATION, AND COLLABORATION

(71) Applicant: Sticky Storm, LLC, Chicago, IL (US)

(72) Inventors: Scott H. Wilson, Chicago, IL (US); Scott Schenone, Chicago, IL (US); Tim Escolin, Seattle, WA (US); Steve Christopher, Chicago, IL (US)

(21) Appl. No.: 14/213,147

(22) Filed: Mar. 14, 2014

Related U.S. Application Data
(60) Provisional application No. 61/785,072, filed on Mar. 14, 2013.

(51) Int. Cl. G06F 3/0482; G06F 3/0486; G06F 3/0488; G06F 3/041

(52) U.S. Cl. CPC G06F 3/0482; G06F 3/041; G06F 3/0486; G06F 3/0488
USPC 715/751; 715/826; 715/769

(57) ABSTRACT

A computer-based system for idea capture, organization and management is shown. The system presents a creation template for capturing ideas and building digital content onto electronic notes. The e-notes may be migrated over on to an electronic board in an organization template. In the latter case, e-notes may be grouped, repositioned, deleted, or copied. Multiple users can access the e-board, and it can be saved or sent as a converted image file or PDF. The e-board has multiple layers, allowing for marking directly on the e-board. Various other features and aspects of the system designed to facilitate group collaboration and team development are disclosed.

### CROSS-REFERENCE TO RELATED APPLICATIONS

This non-provisional patent application claims priority to U.S. Provisional Patent App. No. 61/785,072 filed on Mar. 14, 2013, the entire content of which is incorporated herein by reference in its entirety.

### TECHNICAL FIELD

This invention relates generally to systems and methods for individual or project-oriented design, project development or project management and creative thinking, and more specifically to a software tool for facilitating the same.

### BACKGROUND OF THE INVENTION

Design and development teams, as well as project management groups, are always looking for tools and methods to improve productivity and efficiencies. When an ‘aha’ moment hits, if it is not quickly captured and connected to other ideas or enablers, it will likely be lost. Designers, developers, artists, writers, engineers, business professionals—all are now on the move, and the idea may hit at any time.

The famous 3M® “yellow sticky note” and variations thereof are ubiquitous from those stuck to the mirror to remind someone of a task during the next morning's shave to the whiteboards of organizations that develop products and manage projects all over the planet. Sticky notes are consumed in high volume every day for jotting down information, capturing a fleeting idea, creating reminders, as well as for strategic planning. Their immediacy and temporary nature relieves creative block, organizational paralysis and have become an essential tool for brainstorming in every type of business. Whether for individuals or corporate innovation teams, managing ideas is an essential part of the creative process. And in the digital age creative ideas flow at a chaotic pace. Inspirations happen on the go and need to be captured in the moment. And often our ideas live in more than one place and need to be consolidated effectively.

Furthermore, team members often work remotely yet need to be connected and integrated. The sticky note is a tool of choice for capturing ideas on the fly. Yet once the ideas are captured and have filled walls, sticky notes become a time-consuming task of transcribing, documenting and sharing. Many times great ideas and sparks of innovation are lost in the inefficient follow-through.

Nowadays, people are seldom disconnected from their user computing device, and applications directed at digitally capturing thoughts have emerged. For example, Jott™ serves to capture voice and transfer it to digital text to record a spoken thought. Paper™ is an application directed at drawing or scribbling on an electronic notebook or tablet. Another application called Evernote™ takes this concept a step further and provides for improved file management and recall of scribblings, pictures, lists or other electronic transcriptions. However, none of these existing systems succeed in electronically capturing the functionality, flexibility and constraint-free outside-the-box thinking that a physical whiteboard covered in sticky notes, thoughts and ideas can deliver. Accordingly, there is significant room for improvement in functionality, ease of use, and particularly in collaborative capabilities of electronic applications to assist with idea capture, arrangement, modification, storage and recall to help ensure that the spur-of-the-moment idea is not only captured but shared with a common-goal oriented team.

### SUMMARY OF THE INVENTION

The present invention is a user computer (local) or cloud based application that helps group project design, development or decision-making and/or helps individuals record and organize thoughts. The application captures, organizes, collaborates, and shares ideas, all within the cloud if desired. It allows users to easily cross-pollinate and share content with a team, while tracking the evolution of the idea from beginning to end. The team may be co-located, or could be remotely located and accessing a collaborative project through the application remotely

The present invention allows users to visualize and sketch ideas, upload or take images, and quickly incorporate relevant web-based content. This is done on an electronic rendition of the traditional sticky note, referred to herein as an e-note. Different styles of e-notes allow users to capture various types of content in various forms. The invention then allows e-notes to be managed, grouped, organized, altered and shared in various fashions. Ideas expressed in e-notes can be arranged organically using a variety of layout options on what is referred to herein as an e-board—the digital version of a whiteboard or wall of a “war room” or other creative, idea-generation space. When networked, an e-board can be accessed and manipulated from anywhere in the world, using any variety of compatible computer devices.

Ideas or individual thoughts or concepts are stored in a data unit that is presented to users in a graphical form (an e-note). E-notes can come in multiple sizes, colors, and fonts. They may include image files, text, videos, or free-hand drawing. The application, in the exemplary embodiment, uses one or more mobile workspace devices with capacitive touch-screens that incorporate common properties for recognizing tap, double tap, enlarge, zoom, scroll/swipe and other movements of a finger or stylus. However, the environment could be on a standard desktop using a computer and mouse or other input device.

Features of the application system described herein include, but are not limited to: an idea capturing interface for developing content on e-notes; meta tag and grouping capabilities to help track and organized e-notes across local or global projects; adding multiple users to a collaborative project and running a collective session where an e-board is collectively available for further development, digitally time coded and stamped e-notes for intellectual property recordation purposes; and connectivity with social media or other collaborative programs such as Basecamp®, Dropbox®, Facebook®, Twitter®, Pinterest® or various email programs.

In some embodiments, the application provides a create engine that drives a create interface on which the content of an e-note may be created or modified. The e-note may be saved or “swiped” on to an e-board shown through an organize interface where multiple other e-notes may be present. The organize interface is driven by an organize engine that allows the e-notes on the e-board to be collectively manipulated. For example, e-notes may be added, grouped, moved, deleted, copied, or re-sized on the e-board. The e-board view may show the e-notes in an “organic” pattern where they were last placed by users of the e-board, or may toggle to a “grid” pattern where the e-notes are arranged according to various meta-data stored within the e-notes. The organize interface may also allow users to draw or modify directly on the e-board itself, by toggling to an e-board layer—essentially a transparent third dimension of the user computing device screen that is displaying the e-board. Multiple e-boards can be arranged into a single project, and a project can be controlled by a project leader with multiple members all collaborating on the project.

Thus, the invention provides a new and useful computerized system and method for capturing and organizing thoughts in an electronic medium that facilitates collaboration and goal attainment. While certain aspects of certain embodiments are referenced above, other embodiments, systems, methods, features, and advantages of the present invention will be, or will become, apparent to one having ordinary skill in the art upon examination of the following figures and detailed description. It is intended that all such additional systems, methods, features, and advantages included within this description, be within the scope of the present invention, and be protected by the accompanying claims.

### BRIEF DESCRIPTION OF THE DRAWINGS

The present invention can be better understood with reference to the following figures. It will be understood that the figures are merely exemplary and are not meant to limit the invention as to the size or arrangement of elements shown.

FIG. 1 depicts aspects of a user computing device serving as a general purpose computer for facilitating aspects of the invention.

FIG. 2 depicts contents of a memory component of the user computing device of FIG. 1.

FIG. 3 is an exemplary view of a creation template of the idea management system application, according to an embodiment of the present invention.

FIG. 4 is an exemplary view of the creation template of FIG. 3, where color selection options have been activated.

FIG. 4A is an alternative view of the creation template of FIG. 3, showing different color selection options.

FIG. 5 is an exemplary view of the creation template of FIG. 3, where a text generation option has been activated.

FIG. 6 is an exemplary view of the creation template of FIG. 3, where certain menus have been activated to allow for selection of various options and functionality.

FIG. 7 is an exemplary view of the creation template of FIG. 3, where a digital writing tool has been selected and content has been generated on an electronic note displayed in the creation template.

FIG. 8 is an exemplary view of the creation template of FIG. 3, wherein an electronic note on the creation template is receiving remote content from a matrix paper in accordance with a certain feature of the idea management system application.

FIG. 9 is an exemplary view of the creation template of FIG. 3, where a meta data view option has been activated.

FIG. 10 is an exemplary view of the creation template of FIG. 3, where an electronic note is being removed from the creation template, in accordance with certain embodiments.

FIGS. 11 and 11A are exemplary views of the creation template of FIG. 3, each displaying electronic notes having different master backgrounds.

FIG. 12 is an exemplary view showing transition from the creation template of FIG. 3 to an exemplary organization template using an interconnection icon.

FIG. 13 is an exemplary view of an organization template of the idea management system application, according to an embodiment of the present invention.

FIG. 14 is an exemplary view of the organization template of FIG. 13, where multiple electronic notes have been added.

FIG. 15 is an exemplary view of the organization template of FIG. 13, where a menu for modifying or adding electronic notes has been triggered.

FIG. 16 is an exemplary view of the organization template of FIG. 13, where a menu for re-arranging the electronic notes has been triggered.

FIG. 17 is an exemplary view of the organization template of FIG. 13, where electronic notes have been grouped together, and a particular group has been selected.

FIG. 18 is an exemplary view of the organization template of FIG. 13, where a menu for marking on the electronic board has been triggered.

FIG. 19 is an exemplary view of an organization template according to an embodiment of the present invention, where a menu for selecting electronic board master backgrounds has been triggered.

FIG. 20 is an exemplary view of an organization template according to an embodiment of the present invention, where a user has selecting to add existing electronic notes from other electronic boards or projects.

FIG. 21 is a file management view of the idea management system application, according to an embodiment of the present invention.

FIG. 22 is a project level view within the idea management system application, according to an embodiment of the present invention.

FIG. 23 is an exemplary view of multiple networked computer devices using the collaboration engine of the idea management system application, according to certain embodiments.

### DETAILED DESCRIPTION

The description that follows describes, illustrates and exemplifies one or more particular embodiments of the present invention in accordance with its principles. This description is not provided to limit the invention to the embodiments described herein, but rather to explain and teach the principles of the invention in such a way as to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended claims, either literally or under the doctrine of equivalents.

It should be noted that in the description and drawings, like or substantially similar elements or steps may be labeled with the same reference numerals. However, sometimes these elements or steps may be labeled with differing numbers, such as, for example, in cases where such labeling facilitates a more clear description. Such labeling and drawing practices do not necessarily implicate an underlying substantive purpose. As stated above, the present specification is intended to be taken as a whole and interpreted in accordance with the principles of the present invention as taught herein and understood to one of ordinary skill in the art.

The present invention incorporates computer software that, when operating on any general purpose computing device, converts that computing device to a specialized computing device. Though the software can operate on any such standard computer such as, e.g., a desktop or laptop device, it is primarily intended for use on a user computing device (such as a smart phone or tablet) so that a user can access the software wherever needed. Though the invention is explained using user computing device 140 as an exemplary device, it will be understood that use of the system need not be on such a device and the specific type of device used does not limit the scope of the claimed invention.

Referring to FIG. 1, a schematic diagram of certain aspects of a user computing device 140 is provided. Though illustrated user computing device 140 can be a personal digital assistant (PDA), a smart phone, or other electronic device having a touch screen display, as will be seen the application is illustrated in operation on a tablet, such as an iPad. The user computing device 140 includes an interactive hardware portion 204 and a computer portion 206. The interactive hardware portion 204 can include one or more of a touch screen, a keyboard, a stylus, a joystick, a microphone and the like, which can be arranged in various manners and have different shapes without changing the spirit of the interaction of the hardware portion 204 with the computer portion 206. The touch screen can be a liquid display crystal (LCD), display screen, a plasma screen, a light emitting diode (LED), or any other screen capable of displaying text and images. In the exemplary embodiment described below, the touch screen is a capacitive-based screen designed to receive input from human touch. The computer portion 206 includes an input/output (I/O) portion 208, a central processing unit (CPU) portion 210 (i.e., a microprocessor), and a memory 212. The CPU portion 210 can be any computer-processing unit from a singular microchip to extensive microchip configurations. The memory portion 212 can include, without limitation, any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory portion 212 may incorporate electronic, magnetic, optical, and/or other types of storage media, and can have a distributed architecture where various components are situated remote from one another, but are still accessed by CPU portion 210. The interactive hardware portion 204 is coupled to the I/O portion 208 such that a command entered by a user or customer through the interactive hardware portion 204 will be forwarded to the I/O portion 208, to the processor portion 210 and then to memory portion 212.

As illustrated in FIG. 2, a schematic diagram of the memory portion 212 of FIG. 1 is shown. The memory portion 212 can include or store a database 314, executable programs 300, 326, and 324, and an operating system 322. The database 314 can store data related to prior use of the idea management system application 300 by a user, such as, for example, the user's username, password, preferences, or saved electronic notes and other project materials as discussed below. The executable programs include the idea management system application 300, a touch screen interface application 326, and a wireless network communication software application 324 such as a common browser like Internet Explorer. Various other executable programs may also be stored in memory 212 that are unrelated to the present invention.

When the user computing device 140 is in operation, the processor 210 is configured to execute software stored within the memory 212 to communicate data to and from memory 212 and to generally control operations of user computing device 140 pursuant to the software. The idea management system application 300 and the operating system 322, in whole or in part but typically the latter, are read by the processor 210, perhaps buffered within the processor 210, and then executed. When the application 300 is implemented in software, it can be stored on any computer readable medium for use by or in connection with any computer related system or method. The idea management system application 300 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In some embodiments, the application 300 may exist only partially on the device 140, and may otherwise exist in the cloud or on a remote server that is accessed through the wireless network communication application 324 or otherwise in order to operate the system.

In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). In another embodiment, where the idea management system application 300 is implemented in hardware, it can be implemented with any, or a combination of, the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Functionality related to operation of a capacitive touch screen using, for example, a human finger or stylus, is known and is not considered to be a component of the novelty of the present invention. Accordingly, it is not set forth here in detail. Suffice to say, the touch screen has underlying capacitive sensors that detect an electronic signal resulting from the touch of a conductive body, and the detection can be located and mapped by the sensors for use in generating, for example, a line on the screen, etc. One of skill in the art of application programming would understand that programs and code exist for interconnecting the novel functionality set forth below with the known functionality of a capacitive touch screen. For example, the concepts of detecting a single versus a double tap, detecting two or more points of contact (e.g., fingers) moving away from each other, together, or in unison, and other common methods to interface with a touch screen are assumed to be understood and are incorporated herein.

Before proceeding to a discussion of the function of the idea management system application 300, it will be understood that the application may operate as a stand-alone application that does not require external network access to operate. Initially, the application 300 must be loaded onto the user computing device 140, such as, for example, by downloading the application 300 from a network. However, once downloaded, the application can be launched and can function without remotely-accessed information. However, it will also be understood that users may access additional content, such as stored electronic notes or project data, additional application features, etc., as will be further discussed below, by connecting to the cloud or to a remote server where such additional content may be acquired for use with the application 300. Also, the application may operate in collaboration mode where multiple devices 140 are connected together and simultaneously working on the same project.

Turning to FIG. 3, user computing device 140 has launched the idea management system application 300, and processor 210 has caused a creation template 101 to be generated on touch screen display window 10. The creation template 101 is a digitized notepad that allows users to create or add existing content to an electronic note, or “e-note.” An e-note is essentially a digitized form of a yellow sticky note, and the creation template comprises an infinite stack of them. As a user “peels” an e-note 100 off, a fresh new e-note appears underneath it. E-notes can be saved independently, but typically are associated with an electronic board, or “e-board.” As discussed below, an e-board is a digital whiteboard or wall upon which e-notes are “stuck” and organized. In the hierarchy of application 300, a project is the highest level. A project may be related to any number of things, such as a business plan for an acquisition, the design and development of a new consumer device, a project management tool such as Scrum, or the planning of a fund raising event, etc. Each project may have multiple e-boards relating to one or more aspects of the project. Each e-board may have multiple e-notes, as discussed below.

In the illustrated embodiment, each e-note is associated with an e-board. Though, as discussed below, an e-note may be copied onto other e-boards or even other projects, doing so creates a new e-note that is not connected to its original parent. Accordingly, changes made to the content of a copied in e-note will not be reflected on the parent, nor vice versa. Thus, the parent e-note will remain associated with its e-board and project, and the new copied in e-note will be assigned with the e-board and project it is copied on to. In FIG. 3, e-note 100 is assigned to an e-board named “Clean Sweep,” which appears in the e-board title location 102.

Along the left side of the e-note 100 is a menu portion of the creation template 101. The menu portion includes a color palette 104, an image add icon 120, a text add icon 130 and an undo icon 134. It also includes three different styles of writing utensils 18, 20 and 22, which change the thickness of any markings made on the e-note. Eraser 16 is also provided for use in erasing digital content from the e-note 100. At the bottom left of the e-note 100 is a peel tab 118 that is used to remove the e-note when complete and migrate it on to the e-board. There is also an information icon 14 and a portion of interconnection icon (or “ribbon”) 12, the purposes of which will be discussed below. While this is an exemplary embodiment of the creation template used to describe features and capabilities associated with adding digital content to an e-note and migration of e-notes, it will be understood that features displayed on FIG. 3 could be in different locations on touch screen display window 10, could be larger or smaller, or could present less or fewer options without changing the spirit of the invention.

Turning to FIG. 4, a user has opted to display an expanded color palette 104 to select a color for marking on the e-note 100. Also shown are shade wheel 105 and brightness bar 106, each with a track ball 107 to adjust the color settings. If a user is not satisfied with the color options in color palette 104, he may create his own color using the wheel 105 and bar 106, which will be shown in sample window 109. This is done by sliding the track balls 107 on the wheel and bar. Once a user dials in the color they want, they can add it to the palette 104 by selecting the “X” icon 110. A user may return the palette 104 to the default colors using the options menu. Finally, fill icon 108 can be selected to color the entire background of the e-note 100 with the selected color. E-notes are white by default, but their background can be colored or, as discussed below, have default content added. If there is already digital content on the e-note, this content will always be “on top of” any background added. Thus, filling the background with a solid color does not block out any of the unique e-note content that has already been added. As a result, background colors can be changed at any time—even after an e-note is otherwise complete.

Changing colors will not affect digital content (e.g., drawings, scribblings, text, etc.) already shown on an e-note 100, but colors of individual content may be changed by selecting the content (such as, for example, touching a drawn line to highlight it) and then making a selection from the color palette 104. Also, markers 18, 20 and 22 may each use a different color simultaneously within the creation template. Thus, for example, red could be selected for the thin marker 22 and blue could be selected for the mid-size marker 20. Then, without returning to the color palette 104, a user could draw with red and blue at the same time. The tips of each of the markers 18, 20 and 22 will display the color that they are currently set to create when being used on the e-note 100. To set the color of a marker, a user would highlight the marker by touching it, then select a color from the palette 104 or create a color using the wheel 105 and bar 106. Color can also be used for writing text, but the default is black.

FIG. 4A shows an alternative example of the creation template 101, where additional writing and erasing options are provided. Here, there is a brightness bar 106, but also a contrast bar 103. Additional writing implements are provided, including highlighter 21, which is selected. The selected color has been assigned to the highlighter 21, and an additional lock menu 29 allows a user to lock the selected color to that particular drawing utensil. Thus, instead of the default returning to black, this user's creation template 101 will always show as the selected color, unless again changed by the user. Information such as this would be stored in the database 314 with the user's preferences.

As shown in FIG. 5, selection of text add icon 130 causes the processor 210 to generate a keyboard 24 within the creation template, as well as a text box 26 on the e-note 100. The text box 26 can be re-sized by using two fingers and pulling the box edges together or spreading them apart. This will cause the size of the text to grow or shrink. It can also be moved to other locations on the e-note. After adding text using the keyboard and hitting enter, the keyboard 24 will disappear, as will the box around the text that has been added to the e-note. The text color may be changed by selecting the text (by touching it) and selecting a different color.

FIG. 6 shows two separate menus that can be used in the creation template. The image menu expands when the add image icon 120 is selected. This menu allows a user to add a digital images (such as a .PNG, .JPG, .TIF or similar format files) to the e-note 100. Camera roll selection 122 opens a file window (not shown) that previews the image files resident in database 314 and allows a user to select one, thereby placing it in the center of the e-note 100. From there, the image can be re-sized or repositioned on the e-note. Take photo selection 124 launches a separate camera application resident in memory 212 and uses the application to take a picture. The picture is then converted to a digital file, preferably reduced in file size, and added to the e-note 100. Alternatively, a user may choose the web selection 126, which will launch a separate internet browser application resident in memory 212 through which the user can navigate to a page having the desired picture, and copy it into the creation template 101. In yet another alternative, a user may snap an image with a separate user computing device and wirelessly transmit it to the device running application 300. For example, if a user is operating application 300 in the creation template 101 on a tablet device, they could snap a photo with a smart phone and send it to the tablet device for insertion into an e-note.

It will be understood that the idea management system application 300 does not include software for taking digital pictures, searching the internet or storing digital image files in the database. However, these are common features and capabilities that are enabled by known software that would typically be resident on user computer device 140. Application 300 simply interacts with these other existing applications to facilitate these features. If the applications are not available (for example, if the device 140 is not equipped with a camera capability) selection 124 (for example) will not work.

FIG. 6 also shows an options menu 30. As illustrated, the options menu provides several selections. The save selection 32 allows a user to save the presently displayed e-note. The default is to save it to the open e-board (Clean Sweep, in this case), but it could be saved to other e-boards or projects instead. Doing so would change the e-board name in the title position 102. Style selection 34 allows a user to change the style of the e-note 100. The default is a square pad, but, as discussed below, there are other formats. Share selection 36 allows for migration of the previously displayed e-note outside of the idea management system application 300 altogether. Selecting from one of the various sub-options posts or sends a digital image of the e-note to the directed location. The e-note image is typically stored as a .JPG file, but could be converted to a .PDF or other formats.

In FIG. 7, a user has selected marker 20 and used it to add digital content to e-note 100. The actual physical item used to draw on the e-note could be a capacitive-type stylus, a human finger, or anything with a sufficient electrical charge. While a very simple example, it will be appreciated that considerably more content could be added to e-note 100, such as, for example, digital images, typed or drawn text, a different background color, or more comprehensive notes, etc.

FIG. 8 shows an alternative method for adding digital content to the e-note using a special pen and paper combination off of the device. The specialty paper pad 50 contains a grid that is read by sensors in the pen 52 to identify where the pen nib is drawing spatially on the paper. This information is processed by a microprocessor in the pen and wirelessly transmitted (such as by Bluetooth or other short-wave transmission) to the user computing device 140 where it is received and processed by idea management system application 300. The application 300 uses the information to reproduce on e-note 100 a trace of what is being drawn on the specialty paper 50. Note that line 54 is being simultaneously created on e-note 100 even as it is being drawn on the specialty paper 50 with pen 52. The thickness and color of the line 54 may be selected from the menu options on the creation template 101, just as would be the case if the person were drawing with a finger. One benefit of this method is that improved accuracy and more detail can be delivered to the e-note due to the much more narrow tip of the ink pen 52 than a user's finger, or even most capacitive styli.

FIG. 9 shows a view of the creation template 101 where a user has selected the info icon 14. The info icon 14 directs the processor 210 to “flip over” the current e-note 100 displayed on the creation template 101 to reveal its meta data 86 and allow notes to be added. Meta data is information about an e-note that does not appear as digital content on the face of the e-note, but is rather stored in association with it to help the application 300 identify it. As shown, basic meta data 86 includes the project and e-board with which the e-note is associated, a title of the e-note (in this case, “Tic-Tac-Toe”), and a timestamp of when the e-note was created. It may also include the time when the e-note was last modified, the location where it was created (such as by using GPS associated with the user computing device 140), and, if the e-note was created from a copy of another e-note (its “parent”), identification information about the parent. Other than the e-note title, this information is automatically populated by application 300 when a new e-note 100 is presented in the creation template 100.

Users can also add notes or tags to the meta data when the basic characteristics will not properly identify a set. For example, if a user wants every e-note related to the luxury segment of a particular project to be easily located (regardless of when created, or by whom, etc.), they might tag the e-notes meeting that criterion with an “L”. Other meta data fields cannot be changed by a user, such as, for example, author and timestamp. This allows for system integrity and provides confidence regarding creation dates, which may be important for documenting intellectual property creation, etc.

Meta data 86 can be used for various purposes by the idea management system application 300. First, it can be used to search for and locate e-notes stored in database 314 or remotely on another device or server. For example, a user may want to scroll through all of the e-notes connected with a certain e-board in order to pull certain e-notes into a second e-board. The e-notes can quickly be identified by the application 300 and presented using the meta data. Meta data may also be used, as discussed below, to organize and arrange e-notes on an e-board in a structured fashion. In some embodiments, a user may elect to have the e-board display only e-notes meeting a certain meta-data criterion. Using the “L” for luxury example above, this quickly clears away the clutter in instances where a question or problem relates to only certain e-notes. Once the user is through viewing or supplementing the meta data 86, they tap on the info icon 14 again and the e-note 100 flips back over to reveal the digital content on its front side.

Though an e-note 100 can be saved to an e-board using the traditional options menu 30 method, it can also quickly be saved and migrated using peel tab 118. Specifically, once a user is happy with the digital content on the e-note 100, the user simply places a finger on the lower left corner (peel tab 118) of the e-note and “flicks” the tab to the opposite corner by dragging it upward. As this is done the application 300 will cause the digital, 2-dimensional e-note to appear to take on a third dimension and flip over, just as if someone were tearing a yellow sticky note off a pad. Completing the motion causes the e-note 100 to disappear and be replaced by a new, blank e-note underneath. The original e-note will appear in the landing position 60 on the e-board 70 that the user has open. Though shown in the lower left corner, the peel tab could just as easily appear in a different corner, or along the sides or top or bottom of the e-note and still function in the same way so long as it is grabbed and pulled across the e-note.

While the default is that the new e-note 100 appearing below the one just migrated will be blank, idea management system application 300 allows for the default to be changed by selecting a master background from the options menu. A user may choose from among various pre-set master backgrounds, or may choose to create their own in master background mode. If a master background is selected, each new e-note will initially appear with the master background until it is returned to the default blank e-note. FIGS. 11 and 11A show examples of cases where a user has changed the master background. E-note 100A of FIG. 11 features an image window and lines for text underneath. This might be helpful for using the application to outline a story, for example. E-note 100B of FIG. 11A features music stanzas on which a user may jot down musical notes, thus harnessing the present invention to write music. Various other master backgrounds could be employed to add value and efficiency to use of the system.

In FIG. 12, a user has touched the interconnection icon (also referred to as the ribbon) 13 and is using it to change from the creation template 101 to the organization template 160. Generally speaking, the creation template is used to operate on an individual e-note, while the organization template is used to step back and view multiple e-notes 100 simultaneously on an electronic board or e-board 70. The ribbon 12 is an icon that partially exists on both templates, connecting the two together. In the creation template, pulling the ribbon 12 to the left changes the display of the touch screen display window 10 over to the organization template. In the organization template, pulling the ribbon 12 to the right (from where it appears on the left border) will change the display of the window 10 back over to the creation template. Note that changing between templates in this manner does not migrate the e-note 100 currently being displayed in the creation template, or alter it in any way. It will still be there when the user returns to the creation template 101. In this manner, a user may check something on the e-board 70 while generating or modifying an e-note 100 without having to save or be concerned with losing edits.

In FIG. 13, the user has moved the ribbon 12 all the way to the right of the window 10, and has arrived at the “Clean Sweep” E-board 70. The content of an e-board 70 may be very dense, but in this case, little has been added. The “Tic-Tac-Toe” e-note 100 that was migrated over (see FIG. 10 and related discussion above) is in the landing position 70. This is where the most recently migrated e-note will appear, and where it will remain until it is either moved by the user or bumped over by the migration of another e-note. Above the newly migrated e-note is an add e-note icon 72 that is present in most views. Tapping the icon 72 will return the application 300 to the creation template and to a new, blank e-note. If an e-note was already on the creation template 101 and had content on it, the application 300 will provide a warning and ask the user if they want to save the in-process e-note. The title of the e-board 70 will appear in the title field 71 at the top. The various menu icons along the top will be discussed below, but include file directory icon 90, add e-note icon 73, whiteboard icon 80 and organization icon 74, as well as a share menu 62, which functions in a manner similar to that of submenu 36 described in association with the creation template 101.

Notably, the borders of an e-board 70 are not necessarily defined by the borders of the display window 10. The e-board may extend well beyond the window 10, requiring the user to “pull” portions of the e-board 70 into view that are presently off the screen. Alternatively, a user could zoom out by placing two fingers on the screen and pulling them together. Though this may bring the entire e-board 70 into view, it will incrementally shrink all of the e-notes and other content on the e-board. By centering the portion of the e-board 70 of interest, the user may then zoom back in by placing two fingers on the screen and sliding them apart from one another, so as to return the content to a useful size. Essentially, the e-board 70 is a digital map of the user's thoughts relating to whatever the subject of the e-board is. As those thoughts increase (which may be at a rapid pace where there are a multitude of users), the boundaries of the e-board will grow and e-notes will need to be moved and grouped to make room for more.

FIG. 14 shows an e-board 70 with several e-notes that have been moved off of the landing position 60. A user moves e-notes on the e-board simply by placing a finger on them and moving the finger across the e-board to the desired location. As shown, the tic-tac-toe e-note has been selected by the user. This is done by simply tapping on an e-note. Selection is identified by the border of the e-note showing depth, and by a deletion icon 76 and a duplicate icon 78 appearing on either side of the selected e-note. Once an e-note is selected, selection of the deletion icon removes it from the e-board 70 while selection of the duplication icon creates a copy of it. As discussed before in association with creating copies of e-notes, this creates a completely separate e-note. While the content will initially be identical, if one is modified from that point forward it will not affect the content of the other. Meta data associated with the new copied e-note will identify the parent, and the time stamp it was created as a copy. A selected e-note 100 may also be rotated or moved to another position on the e-board 70 by dragging it with the user's finger. It may also be returned to the creation template for further editing by double tapping it.

In FIG. 15, a user has selected add e-note menu icon 74. As previously noted, not all e-notes 100 are necessarily square. While that is the default, e-note menu icon 74 allows a user to start a new e-note having a different style. Though several options are illustrated, there are many other possible shapes and sizes such as circles, triangles, arrows, etc. These options correspond to those of style change selection 34 of the options menu 30 in the creation template 101. To further illustrate the point, the e-board 70 shown in the organization template 160 displays e-notes having various different styles that have been migrated over. As indicated, one style is to have a traditional square e-note with a tab 136 attached to it. This is one way to visually make an e-note stand out on the e-board. For example, those e-notes having red tabs 136 may be of some particular importance, etc. FIG. 15 also illustrates that e-notes can overlap. When a first e-note is pulled over the top of a portion of a second e-note, the covered portion of the second e-note will no longer be visible in the organic view.

In the view of the organization template 160 of FIG. 16, a user has selected the organization menu icon 74 to launch the organization menu. As shown, this menu allows a user to toggle between an organic view and a grid view. The organic view is based on where the user has placed, organized and grouped the e-notes on the e-board. There are no limits or controls, allowing the user to free-associate. In contrast, the grid view automatically displays all of the e-notes 100 resident on the e-board 70 in an organized fashion, such as shown on in FIG. 16. The organization is based on some meta data factor specified by the user. The default factor is the date and time at which the e-note was migrated to the e-board. However, a user could change this default to cause the application 300 to list and organize the e-notes by various other factors, such as, for example, the author of the e-note, the date it was last modified, the group it has been placed in, if any, etc.

Importantly, by migrating to grid view, a user does not lose the organization they had set up in the organic view. Rather, the exact positions and groupings of the various e-notes are recorded by the application 300 prior to conversion into grid view, so that a user may simply select organic view to return all of the e-notes to their previous locations. In this manner, a user may toggle between grid and organic view to “sort” the e-notes by some feature or another, and then return it to normal. Using the share menu 62, the user can also send an image of the e-board in grid view to email or a printer, etc., so that it can be referenced while viewing the e-board 70 in organic view.

While on the topic of sorting, the e-note meta-data may also be used by application 300 to automatically cause the opening screen to present e-notes that match certain meta data criteria on an e-board in accordance with user preferences. For example, in a case where meta data is stored relating to where an e-note is created (based on, for example GPS capability of the user computing device 140), the application 300 may show e-notes at startup that were created in the same place or close by. Thus, if a person uses the application 300 primarily at work and at home, but for different projects (e.g., work vs. play), the application 300 can predict what material to present based on information about the location at startup.

In FIG. 17, an e-board 70 is shown where e-notes have been grouped together. Grouping of e-notes allows them to be moved or otherwise operated on simultaneously. To group e-notes, a user selects a first e-note 100, and then selects one or more other ones with a second finger without releasing the finger from the first e-note. In alternative embodiments, a 2-finger tap may be used for grouping, where a 2-finger tap is synonymous with selecting while the CTRL key is down in traditional keyboard input systems. Once grouped, the application 300 will automatically move the selected e-notes into a close location on the e-board 70. E-notes may not be grouped and remain in distant locations on the e-board. In alternative embodiments, groups may be formed by pulling multiple e-notes together on the e-board and circling them with a finger or styli. When e-notes are grouped, the user is prompted to assign a group title 64 that may be automatically added to the meta data for each e-note member of the group. In addition, groups may have unique meta data that is associated with the group name title 64 and its tag, as shown on the e-board. In this manner, the same type of search and sort functionality described above in association with e-notes can also be applied to groups. The group titles 64 may also be shown on the e-board 70 next to the group and will then move with the group. Also, multiple groups may be pulled together into a larger group, or split apart into sub-groups.

In the case of FIG. 17, Group 4 has been selected. An e-note that is a member of a group may still be individually selected (and copied or deleted) by a single tap on the e-note. If it is moved, the entire group will move with it. However, a double tap on any e-note within the group causes the entire group to be selected, as is the case with Group 4. In this manner, an entire group may be deleted or copied.

In FIG. 18, a user has selected whiteboard icon 80, and whiteboard menu 81 has appeared on the right hand side of the organization template 160. When the whiteboard menu 81 is present in the organization view, a second layer of the e-board is brought to the surface allowing a user to annotate directly on the e-board itself. When the second layer is activated, the first layer on which the e-notes reside is still visible, but is not active. In other words, e-notes may not be selected or moved when the second layer of the e-board is activated. Rather, they are frozen in place. While the second layer is active, the user can draw freehand on the e-board, such as is shown in FIG. 18. Colors and typing text may also be added, in a manner similar to that of the e-note. As indicated, markings may be made on the second layer directly over e-notes existent in the first layer. Either the first layer or the second layer (or both combined) can be shared via share menu 62 as previously discussed.

Though the drawing menu 81 as shown has reduced functionality, it could be as involved as that shown in FIG. 3 in association with the creation template 101. In this case, the menu includes a whiteboard pen 87 and whiteboard eraser 88 that can be used to affect digital content directly on the e-board 70. If desired, the second layer of the e-board 70 can be cleared of all content by simply hitting the clear icon 83. Selecting the hide icon 82 will hide the first layer of the e-board (e.g., the e-notes) so that only the second layer is visible. Clicking it again returns the visibility of the first layer. Color selection 85 allows a user to change the color of the whiteboard pen 87.

When the whiteboard icon 80 is selected a second time, the organization template will return to the first layer of the e-board. Any content added to the second layer will remain visible, even if it is across an e-note. However, the content added in the second layer cannot be moved. Rather, it is fixed on the e-board and can only be erased when the second layer is active. Thus, if an e-note that has second layer writing over it is moved, the second layer writing will remain in the space on the e-board vacated by the e-note, and the e-note will no longer show the content in its new location.

Much like e-notes can use a different master background, e-boards may have a master background in the second layer. In FIG. 19, a user has selected file directory icon 90, which has provided the option to add a master background 92. This may be done when setting up a new e-board, or may be added to a pre-existing e-board. Here, the user has selected a particular master background from a list of options, and is dragging it over on to the e-board. When complete, the selected master background will appear in the second layer, and my facilitate the sorting and grouping of e-notes. For example, in FIG. 20, the master background 92 selected in FIG. 17 appears on e-board 70, which has been populated with e-notes in accordance with certain characteristics defined by the content of the master background.

FIG. 20 also shows additional options for adding pre-existing e-notes to the e-board 70. This is also done using file directory icon 90. The user has selected to add an e-note from the file directory menu. Unlike selecting the add e-note menu icon 73, this does not generate a new, blank e-note. Rather, it allows a user the opportunity to search for and identify pre-existing e-notes from other e-boards or other projects for copying into the active e-board. In this case, the user is looking at e-notes in a project titled “Catch All”, which has four e-boards, Steve, Scott, Jacob and Tim. The project name 96 and e-board names 94 associated with that project appear on the left. More specifically, the user has selected the Jacob e-board, which causes the Application to show all of the e-notes associated with that e-board in a scroll 98 at the bottom of the window 10. When the user finds an e-note in the scroll that he wants to add to the active “Clean Sweep” e-board of Project X, he simply drags the e-note onto the e-board 70. In this case, he may use the master background to place such as e-note into a particular quadrant. Again, this action will not remove the e-note from the Jacob e-board or the Catch All project. Rather, it creates a duplicate that can be independently modified going forward. The original e-note that was copied is unaffected. Though not shown, the user may further limit the search by entering particular meta data characteristics. For example, e-note scroll 98 may only show e-notes created before a specific date entered as a search criterion.

FIG. 21 shows a top level view from within the idea management system application 300 of various projects 84. This is a view that a user might see upon logging on to the system. The user will be shown any projects 84 to which the user has access. Selection of a project, such as our familiar Project X, will cause the application 300 to show a project view such as that in FIG. 22. Here, Project X has various e-boards associated with it. Each e-board is identified by showing a representative e-note from within that e-board. Selection of an e-board would take the user to the organization template 160, which would display the selected e-board 70.

Though the Application 300 may be used by a single individual for personal use, it is most helpful when used for collaborative projects by groups of people. In such cases, each project will have a project leader and may have numerous group members. Typically, each member of a project would have their own user device 140 with which to access the project. Project files may be brought down locally to memory database 314 temporarily, but are generally stored in a centrally accessible location, or in the cloud. The project leader will have certain access rights and capabilities that the users may not. For example, the project leader will be able to grant or deny access to individual e-boards within the project. That access may be read-only access, or may have full create privileges. The project leader may also disable certain functionality, such as, for example, the ability to copy e-notes out of a particular e-board or project.

Multiple project members may be simultaneously working on a centrally-located e-board of a given project. In that case, the user computer device 160 connected to the centrally-located computer housing the e-board will get real-time updates as content is added, moved, or deleted from the e-board. However, only one user can “check-out” a specific e-note at a given time. An e-note cannot be in the creation template 101 of multiple devices simultaneously. Thus, if a first project member checks out our Tic-Tac-Toe e-note, it will be identified on the e-board as being “checked-out” to other project members viewing the e-board. It may also indicate who has it checked out. While checked out, the e-note may be moved or grouped, but not deleted.

When a project member launches the Application 300 after an absence and opens up an e-board that has been modified since he last saw it, the project member can access a list of changes that include what was changed, by whom and when. All such changes are recorded, and the Application also records when the last time a user viewed a given e-board. Thus, it is capable of providing a list of edits unique to the project member based on the last time he accessed the e-board. In some embodiments, the Application may also provide a snapshot of what the e-board looked like when the project member last accessed it, for him to visually compare to its present state. In others, each e-board may autosave as a PDF or image file at pre-set intervals. This helps generate a historical record of idea development that may be helpful in proving invention.

FIG. 23 shows a collaboration engine of the present invention at work. While, as described above, multiple project members may be simultaneously working on the same e-board, they may be doing it independently on their own devices without knowledge of what the other is doing. Alternatively, they could be participating in an active collaboration session where they are all working together. In the example of FIG. 23, a first user is running idea management system application 300 on his smart phone 140A, and is in the creation template 101 editing or creating a new e-note. A second user is working off a tablet device 140B, and is viewing an e-board in organization template 160. Both the smart phone 140A and the tablet 140B are remotely connected to a large wall-mounted screen 140C (although this could be any computer screen). Screen 140C is showing a modified version of the organization template that maximizes the visible area of the e-board 70 and does not provide menu options. This scenario may be that users of the smart phone 140A and the tablet device 140B are sitting around a table with several other users (also connected through their own devices) discussing the project and working through ideas displayed on the common screen 140C. Alternatively, the group members may be running a net meeting and may be spread across the country, but each viewing the same content through a networked desktop. In either event, the Application 300 provides substantial benefit and capability to collaborate in furtherance of design development.

Accordingly, it should now be clear how the idea management system application 300 operates to capture thoughts and put them to immediate use or share them with others in a digital, traceable, searchable manner. Any process descriptions or operative steps in using the idea management system application 300 should be understood to be exemplary, and alternate or additional steps or series of steps may be included within the scope of the present invention, as would be understood by those having ordinary skill in the art. It should be emphasized that the above-described exemplary embodiments of the present invention, and particularly any “preferred” embodiments, are possible examples of implementations, merely set forth for a clear understanding of the principles of the invention. Other variations and modifications may be made to the above-described embodiments of the invention without substantially departing from the spirit and principles of the invention. All such modifications are intended to be included herein within the scope of this disclosure and the present invention and protected by the following claims.

What is claimed is:

1. A computer device comprising:
a processor;
a touch screen display window; and
a memory comprising software instructions executed by the processor to present a creation template and alternatively a organization template on the touch screen display window;
wherein the creation template comprises a menu portion and a second portion for providing an electronic note to which a user may add digital content by selecting menu options from the menu portion and then marking on the electronic note with the user's finger;
wherein the organization template presents an electronic board on which a plurality of electronic notes can be simultaneously displayed and arranged;
and wherein, when the organization template is being presented, and upon receiving indication of a user's desire to modify the digital content of a first electronic note displayed on the electronic board, the processor causes the touch screen display window to replace the organization template with the creation template, in which the first electronic note is displayed in the second portion.

2. The computer device of claim 1, wherein touching the touch screen display window at a first edge or corner of an electronic note displayed in the creation template and dragging across the electronic note to the opposing edge or corner causes the processor to place the electronic note on the electronic board and to present a new, blank electronic note in the second portion of the creation template.

3. The computer device of claim 2, wherein touching the touch screen display window at the first edge or corner of the electronic note displayed in the creation template and beginning to drag across the electronic note to the opposing edge or corner causes the first edge or corner to appear to peel over and follow the point of touch, revealing a next, blank electronic note underneath.

4. The computer device of claim 1, wherein a user may toggle between the creation template and the organization template without removing the electronic note being displayed in the creation template by selecting and dragging an interconnection icon comprising first and second portions, wherein the first portion appears on a border of the creation template and the second portion appears on an adjoining border of the organization template.

5. The computer device of claim 1, wherein each of the plurality of electronic notes displayed on the electronic board contain unique meta data defining at least one characteristic about the electronic notes from the set of characteristics including: the date the electronic note was last modified, the geographic location where the note was created, the author of the electronic note, the name of the electronic note, and the date the electronic note was created.

6. The computer of claim 5, wherein the processor can identify one or more electronic notes from among the plurality of electronic notes by searching the meta data associated with each of the plurality of electronic notes.

7. The computer device of claim 1, wherein, when the touch screen display window is presenting the organization template, a user may select and move one or more of the plurality of electronic notes displayed on the electronic board to a different location on the electronic board.

8. The computer device of claim 7, wherein a user may digitally connect multiple electronic notes from among the plurality of electronic notes displayed on the electronic board together so that they may be selected, moved, labeled, or deleted as a group.

9. The computer device of claim 7, wherein the organization template provides a grid view option that, when selected, causes the processor to arrange the electronic notes displayed on the electronic board into an organized pattern.

10. The computer device of claim 9, wherein the organized pattern is defined by a characteristic found in meta data associated with each of the electronic notes.

11. The computer device of claim 1, wherein the organization template comprises:
a first digital level on which touch interface with the touch screen display window causes selection of one or more of the electronic notes displayed on the electronic board; and
a second digital level on which touch interface with the touch screen display window causes the addition of digital content and markings directly to the electronic board in spaces between the electronic notes.

12. A system for creating and organizing digital content using at least a first computer device having a touch screen display, the system comprising:
a creation engine for instructing a processor within the first computer device to generate a creation template on the touch screen display, wherein the creation template provides:
a first electronic note to which digital content may be added by human touch, and
a menu section for selecting options that control the format of the digital content to be added; and
an organization engine for instructing the processor within the first computer device to generate an organization template on the touch screen display, wherein the organization template provides an electronic board containing a plurality of electronic notes, each electronic note containing digital content added using the creation template; wherein the organization template comprises:
a first layer on which each of the plurality of electronic notes can be individually selected and repositioned on the electronic board by human touch, and
a second layer on which digital whiteboard content can be added by human touch directly to the electronic board.

13. The system of claim 12, wherein the first electronic note may be removed from the creation template and added to the electronic board by sliding a finger from a first edge or corner of the first electronic note to an opposite edge or corner of the electronic note.

14. The system of claim 13, wherein the first edge or corner of the first electronic note stays with the finger as it is slid to the opposite edge or corner of the first electronic note, revealing a second, blank electronic note underneath.

15. The system of claim 12, wherein, when the second layer is active, the plurality of electronic notes and their respective digital content are visible on the electronic board, but they cannot be selected, repositioned, or deleted.

16. The system of claim 15, wherein, when the first layer is active, digital whiteboard content previously added to the electronic board is visible, but is not affected by selection or repositioning of electronic notes that may pass over or be placed on top of the digital whiteboard content.

17. The system of claim 12, further comprising a collaboration engine for interconnecting the creation template shown on the first computing device and a creation template shown on at least a second computer device having a touch screen display with an electronic board displayed on an organization template of a third computer device having a touch screen display, wherein the collaboration engine causes electronic notes generated on the creation templates of the first and second computers to appear on the electronic board displayed on the third computer when migrated by a user of the first or second computers.

18. The system of claim 17, wherein the users of the first and second computers migrate electronic notes from their respective creation templates by touching a corner or edge of the electronic notes and making a flicking motion toward the touch screen display of the third computer with their finger.

19. The system of claim 17, wherein each of the first, second and third computers are located remotely from one another and connected through a secure internet connection established by the collaboration engine.

20. A method for creating and organizing digital content comprising the steps of:
receiving selection of a format for creating digital content from an options menu displayed on a creation template of a touch screen display of a computer device;
using the format, adding digital content to a first electronic note displayed on the creation template;
automatically assigning by a processor of the computer device searchable meta data to the first electronic note;
migrating the first electronic note to an electronic board displayed in an organization template of the touch screen display in which multiple other electronic notes, each having unique digital content, are displayed; and
electronically connecting the first electronic note together with at least one other electronic note from among the multiple other electronic notes into a group so that the electronic notes comprising the group can all be repositioned on the electronic board by repositioning a single electronic note from the group.
